(19) United States
(12) Patent Application Publication
(10) Pub. No.: US 2004/0110512 A1
(43) Pub. Date: Jun. 10, 2004

(54) Method for resource management of a CCP in a mobile communication system and a mobile communication system comprising the CCP

(75) Inventor: Chong Mann Lim, Suwon-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/724,115

(22) Filed: Dec. 1, 2003

(30) Foreign Application Priority Data
Dec. 2, 2002 (KR) 10-2002-0075888

(51) Int. Cl. H04Q 7/20

(52) U.S. Cl. 455/450; 455/509

(57) ABSTRACT

The present invention provides a method and system for resource management of a call control processor. In the mobile communication system even if resource allocation for an origination call or a page response call of a mobile hand station is impossible, the call control processor checks whether any other call has been released or any other processor has returned to the normal state from the abnormal state within certain time and accordingly makes a request again for re-allocation of available resources to the resource management processor within a certain pre-determined time period instead of transmitting a call release signal.

### BACKGROUND OF THE INVENTION

1. Field of the Invention

The present invention relates to resource management of a call control processor in a mobile communication system.

2. Background of the Related Art

In a related art mobile communication system, if a mobile hand station sends an origination call or a page response call to a base station transceiver subsystem (hereinafter, referred to as “base station” or “BTS”), the BTS requests that the relevant base station controller (BSC) establishes call connection. The base station controller then requests that the relevant resource management processor allocate resources for the call.

FIG. 1 is a diagram illustrating an ordinary mobile communication system. In order to make a call, a mobile hand station 110 sends an origination call (ms_org_msg) to the BTS 120. Then, the BTS 120 transmits an origination request message to the call control processor (CCP) 131 of the base station controller 130. The CCP 131 sends a service request message (CM Service Request) to the mobile switching center (MSC) 140.

The BTS 120 transmits a response message (bs_ack_order) to the mobile hand station 110 in response to the origination call (ms_org_msg). When the mobile hand station 110 receives the response message (bs_ack_order) of the BTS 120, a timer in the mobile hand station 110 starts counting time and waits for call connection for a certain period of time.

The term “call connection” means the state where the call has been connected upon appropriate resource allocation according to the call connection request. The time during which the call connection is waited for is the appropriate length of time typically within the range of a few seconds to tens of seconds. For example, in an ordinary commercial mobile communication system, call connection wait time is approximately for 12 seconds.

In other words, after the mobile hand station 110 requests call connection and receives the BTS's response message, a pre-determined time (e.g., 12 seconds) is assigned for the call connection upon relevant resource allocation. Also, the CCP 131 sends a resource allocation request (AllocReq) to the resource management processor for the resource allocation required for the mobile hand station's origination call.

Examples of the resource management processor are the service data unit (SDU) management processor 132 which manages SDU's, the network control processor NCP) 133 which manages network resources, and the base station processor (BSP) 121 which manages channels. The SDU management processor 132 and the network control processor 133 are preferably included in the base station controller 130. The base station processor 121 is preferably included in the base station 120. Alternatively, the SDU management processor 132 may be included in the CCP 131 within the base station control processor 130.

Thus, in order to request allocation of resources such as SDUs, network resources or channels, the CCP 131 sends resource allocation request to the SDU management processor 132, the network control processor 133 or the base station processor 121.

If relevant resources are available, the above-mentioned resource management processor allocates resources for the call of the mobile hand station 110. However, if relevant resources are not available or if the resource allocation is impossible, the resource management processor transmits resource allocation failure message (NOK_Rsp) to the CCP 131.

The CCP 131 that received NOK_Rsp sends a call release order (rel_order) to the base station 120 in order to release the call of the mobile hand station. The base station 120 transmits the rel_order to the mobile hand station 110 for the release of the call of the mobile hand station 110.

If the call is released as described above, the relevant mobile hand station 110 sends an origination call (ms_org_msg) again to the base station 120. Thereafter, upon repeatedly going through the series of steps including the resource allocation, the mobile hand station 110 may receive the requested communication service.

Thus, if resource allocation failure occurs, the mobile hand station consumes additional power and time for sending the call request again. Further, in the overall system, mobile hand stations may experience interference with other mobile hand stations. Also, if the step of call request is repeated again and again, the possibility of call detection error that may arise at the time of the mobile hand station's call detection would increase. Moreover, because there is no further response in the case that there is page response failure, no further service may be provided according to the related art technology in the related art.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

In order to solve the above problems, the embodiments of present invention provide a method of resource management of a call control processor through which, even if a resource management processor fails to allocate resources upon receiving the call control processor's request for resource allocation, the call control processor makes a request again for allocation of available resources to the resource management processor within a certain pre-determined time period instead of transmitting a call release signal. Thus, the use of the resource management method of a call control processor according to the present invention may reduce the waste of power and time caused by re-request made after the call release, interference with other mobile hand stations and error rate caused by repeated call detections.

Thus, an object of embodiments of the present invention is to provide a method for resource management in a mobile communication system.

An object of embodiments of the present invention is to provide resource management of a call control processor in a mobile communication system.

An object of embodiments of the present invention is to provide a mobile communication system having a call control processor that conducts the resource management.

In order to attain the objects stated above, the present invention provides a method for resource management of a call control processor to allocate resources in response to a mobile hand station's origination call or page response call in a mobile communication system comprising: (a) sending a request for resource allocation at the call control processor to a resource management processor; (b) if resource allocation is impossible, transmitting resource allocation failure message at the resource management processor to the call control processor; (c) if the call control processor receives resource allocation failure message, checking at the call control processor whether any other call has been released or whether any other processor has returned to the normal state from the abnormal state within certain time; and (d) if it is determined from said step (c) that any other call has been released or that any other processor has returned to the normal state from the abnormal state within certain time, sending a request for re-allocation of available resources at the call control processor to the resource management processor.

If the re-allocation requested by the call control processor to the resource management processor in said step (d) is impossible, the method according to the present invention repeats said steps (b) through (d) again. The repetitions of steps (b) through (d) in this case may be limited to a certain number.

Also, the present invention provides a mobile communication system comprising mobile hand stations, base stations, base station controllers, and a mobile switching center (MSC), wherein the base station controller comprises a call control processor that sends a request for resource allocation to a resource management processor and if the call control processor receives resource allocation failure message from the resource management processor, the call control processor checks whether any other call has been released or whether any other processor has returned to the normal state from the abnormal state within certain time and, if it is determined that any other call has been released or that any other processor has returned to the normal state from the abnormal state within certain time, the call control processor sends a request for re-allocation of available resources to the resource management processor.

Preferably, the resource management processors may be SDU management processors managing service data units (SDU), network control processors managing network resources, or base station processors managing channels. Accordingly, the call control processor sends a request to an SDU management processor, a network control processor, or a base station processor for allocation of SDUs, network resources, or channels.

Examples of cases where the resource allocation may be impossible in said step (b) of the method for resource management of a call control processor according to the present invention are: a case where there is no further available resource because all of the resources have already been allocated to other calls in busy hour; and a case where there is lack of resources that may be allocated because some processors are in abnormal states.

After a mobile hand station requests call connection and receives a base station's response message, certain pre-determined time (ordinarily, 12 seconds) is assigned for the call connection upon relevant resource allocation (Of course, if requested resources are allocated before the pre-determined time passes, the call may be connected immediately thereupon). Thus, during the certain pre-determined time period, even if resources are not allocated, the mobile hand station continues waiting for the call connection.

If the call control processor receives resource allocation failure message upon the failure of resource allocation in said step (b), the call control processor checks at said step (c) whether any other call has been released or any other processor has returned to the normal state from the abnormal state within certain time (e.g., 12 seconds).

If, within said certain time, any other call has been released or any other processor returned to the normal state from the abnormal state, available resources may be re-allocated while the relevant call connection is maintained without disconnection. Because the call control processor may monitor call connection or call release status of all calls, the call control processor may recognize other calls' releases, if any, besides the origination call.

Further, the call control processor may check whether any other processor returned to the normal state from the abnormal state within certain time. Said any other processor may be any processor that makes the resource allocation impossible. Preferably, it is a resource management processor that is in charge of resource allocation.

The call control processor may check whether any other processor has returned from the abnormal state to the normal state by using processor state blocks or by using a base station manager (BSM). Preferably, a processor comprises a processor state block that indicates the state of the relevant processor. Thus, the call control processor may check the other processors' return to the normal state by checking state blocks of other processors.

Alternatively, processors can be programmed so that if a processor returns to the normal state from the abnormal state, it would notify the call control processor of the occurrence of this event. In this case, the call control processor may recognize the relevant processor's return to the normal state through such program.

Preferably, a base station controller of a mobile communication system comprises a base station manager (BSM) that manages hardware and software within the base station controller, collects information related to the base station operation, monitors operations of base stations, monitors devices affected by detected malfunction, tests through commands, and collects statistics, etc. Thus, by checking said base station manager, the call control processor may determine whether a processor which has been in the abnormal state has returned to the normal state.

Alternatively, if the system is programmed so that the base station manager would notify the call control processor of the occurrence of an event where a processor that has been in the abnormal state returns to the normal state, the call control processor may thus recognize the return of the processor from the abnormal state to the normal state.

Accordingly, upon checking whether another call has been released within certain time or another processor has returned to the normal state, the call control processor may request that the resource management processor re-allocate available resources.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram illustrating an ordinary mobile communication system in the related art;

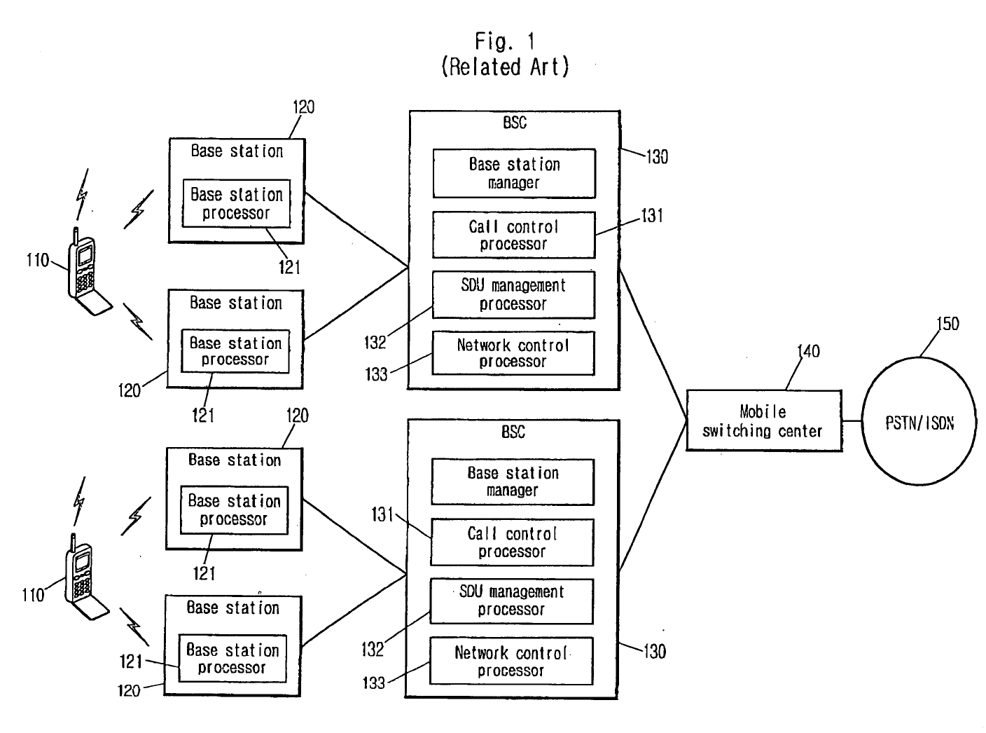

FIG. 2 illustrates the related art method of processing a mobile hand station's origination call;

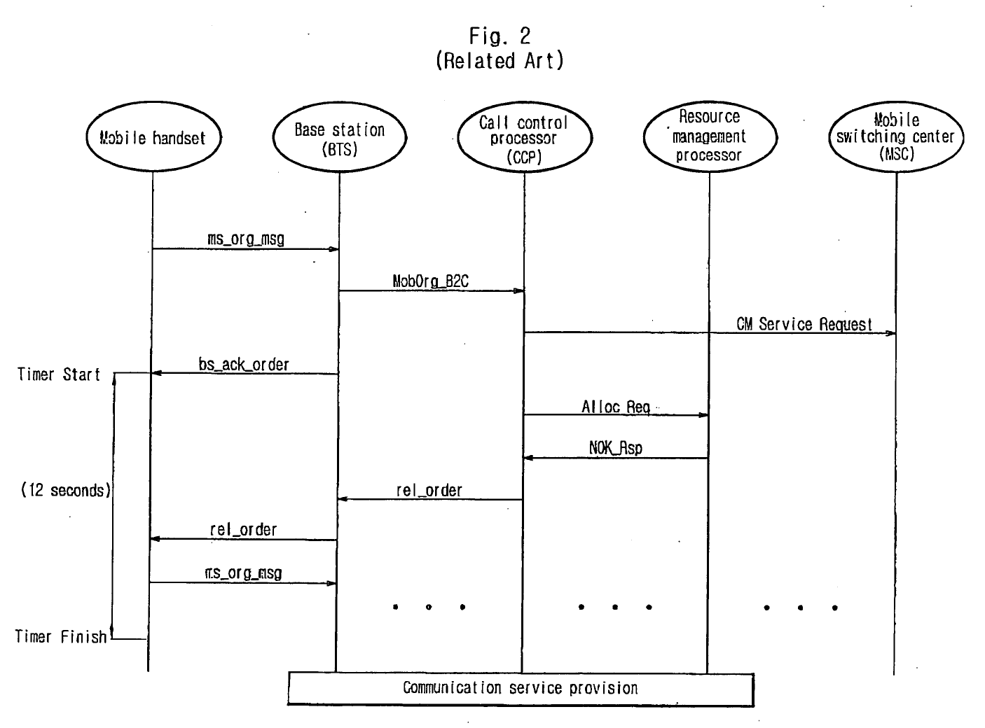

FIG. 3 illustrates the method of processing a mobile hand station's origination call according to an embodiment of the present invention;

FIG. 4 is a flow chart illustrating the method of resource management of a call control processor according to an embodiment of the present invention;

FIG. 5A and FIG. 5B are flow charts explaining in detail steps illustrated in FIG. 4 if processor state blocks are used; and

FIG. 6A and FIG. 6B are flow charts explaining in detail steps illustrated in FIG. 4 if a base station manager is used.

### DETAILED DESCRIPTION OF PREFERRED EMBODIMENTS

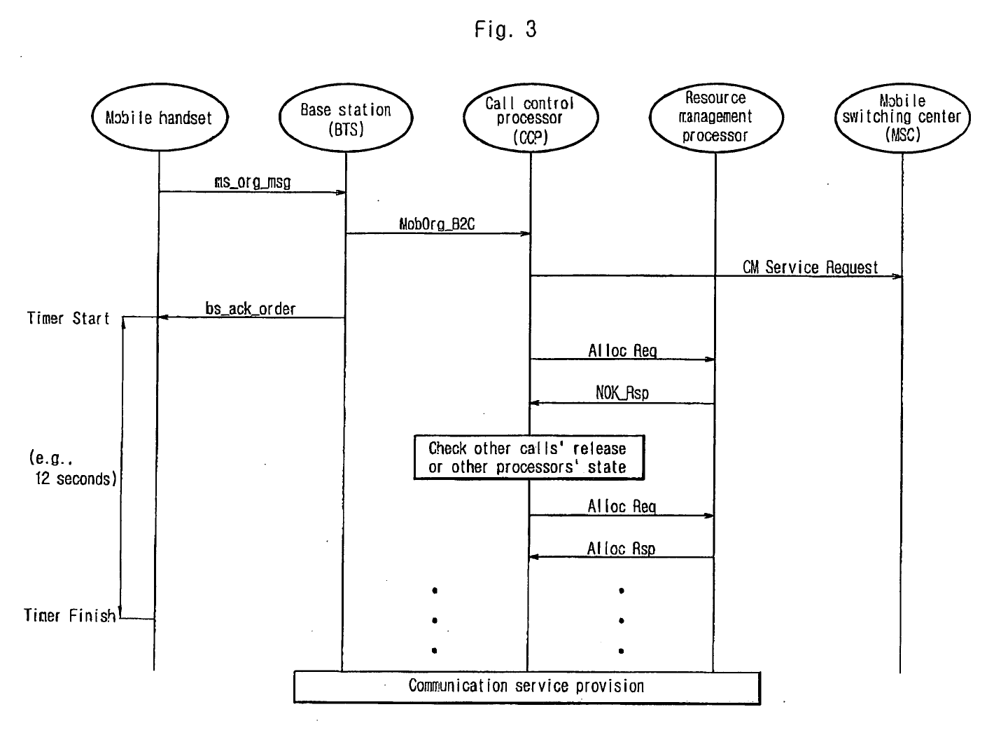

FIG. 3 illustrates the method of processing a mobile hand station's origination call according to an embodiment of the present invention. In order to make a call, a mobile hand station sends an origination call (ms_org_msg) to a base station. Then, the base station sends an origination request (MobOrg_B2C) to the call control processor of the base station controller. The call control processor sends a service request message (CM Service Request) to the mobile switching center (MSC).

Further, the base station sends a response message (bs_ack_order) to the mobile hand station in response to the origination call (ms_org_msg). When the mobile hand station receives the response message (bs_ack_order) of the base station, the timer included in the mobile hand station starts counting certain time (e.g., 12 seconds), waiting for the call connection.

On the other hand, the call control processor requests that a resource management processor allocate resources (AllocReq) for the mobile hand station's origination call. Specifically, the call control processor makes a request to the SDU management processor, the network control processor, or the base station processor for allocation of resources such as SDUs, network resources, or channels.

If such resource allocation is possible, the relevant resource management processor allocates requested resources for the call of the mobile hand station. If the resource allocation is impossible, the resource management processor sends a resource allocation failure message (NOK₁₃ Rsp) to the call control processor.

Then, the call control processor that received the resource allocation failure message (NOK_Rsp) checks whether any other call has been released or any other processor has returned to the normal state from the abnormal state within certain time, instead of sending a command for releasing the call of the mobile hand station. As used herein, the terms “normal state” and “abnormal state” generally refer to a state where resources are available or unavailable, respectively. If it is determined that another call has been released or another processor has returned to the normal state from the abnormal state, the call control processor sends the resource management processor a message requesting re-allocation of available resources (AllocReq).

Thereupon, if the resource allocation is possible, the resource management processor allocates resources for the call of the mobile hand station (AllocRsp). After the call process is performed, the mobile hand station may receive communication service. Accordingly, even if resource allocation for the mobile hand station's call fails, embodiments of the present invention request re-allocation of other available resources, thus maintaining the current call without the call release.

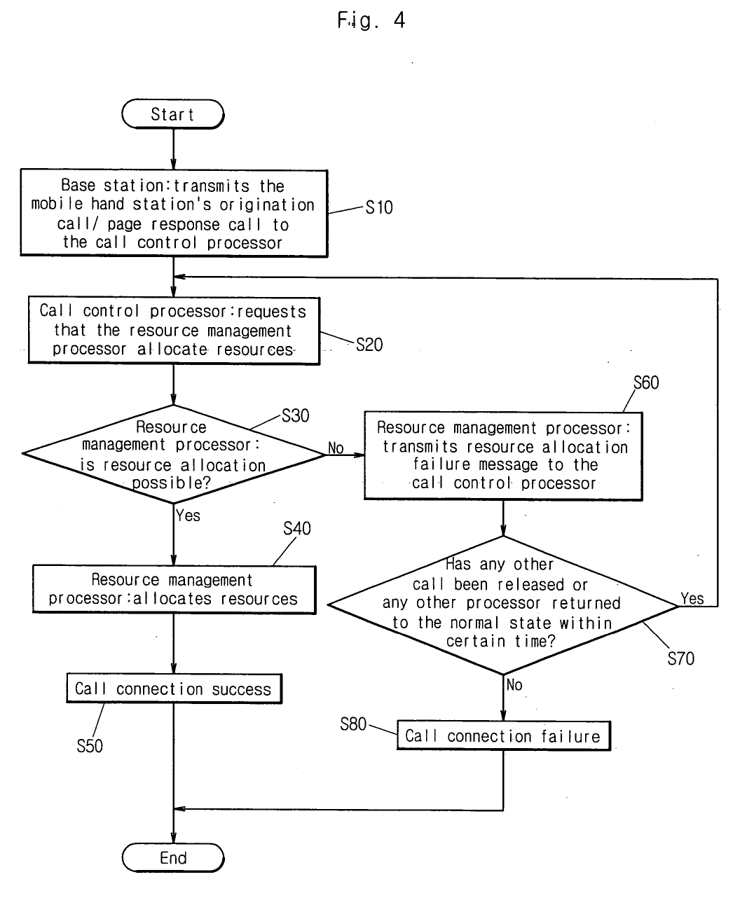

FIG. 4 is a flow chart illustrating the method of resource management of a call control processor according to an embodiment of the present invention. In order to make a call or respond to a call, a mobile hand station transmits an origination call or a page response call to the base station. The base station transmits the origination call or the page response call to the call control processor of the base station controller according to the request of the mobile hand station (S10).

For the resource allocation required for the mobile hand station's call, the call control processor requests that the resource management processor allocate resources (S20). Thus, the possibility of resource allocation is determined (S30). If resource allocation is possible, resources are allocated for the call of the mobile hand station (S40).

In contrast, if resource allocation is not possible or denied, the resource management processor transmits message notifying the resource allocation failure to the call control processor (S60). The call control processor that received the resource allocation failure message checks whether any other call has been released or any other processor has returned to the normal state from the abnormal state within a certain time, instead of transmitting a call release signal (S70).

If it is determined that any call has been released or any processor has returned to the normal state from the abnormal state, the call control processor requests that the resource management processor re-allocate available resources (S20). Accordingly, if resource allocation is possible, resources are allocated for the call of the mobile hand station (S40). Upon call connection established through the ordinary call processing (S50), the communication service is provided.

If it is determined in step S70 that there is no available resource (e.g. no other call released, no other processor returns to the normal state within certain time, and the like), the connection for the mobile hand station's call fails (S80). The state of other processors (i.e., whether other processors have returned to the normal state) may be checked at step S70 by using processor state blocks or by using a base station manager (BSM).

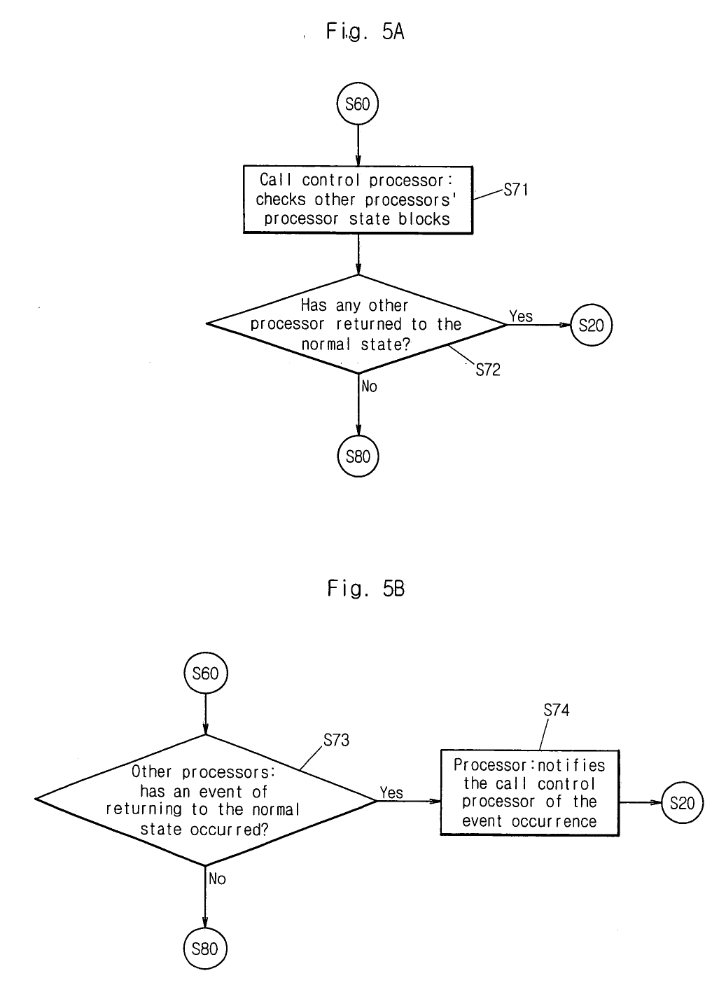

FIG. 5A is an example of a detailed diagram of step S70 in the case when processor state blocks are used. The call control processor checks the processor state blocks (S71). Thus, the state of certain processors can be checked, e.g., has the processor returned to the normal state from the abnormal state (S72).

Alternatively, as illustrated in FIG. 5B, if any other processor returns to the normal state from the abnormal state (S73), the relevant processor notifies the call control processor of the occurrence of such an event (S74). Thus, the call control processor may recognize the other processor's returning to the normal state.

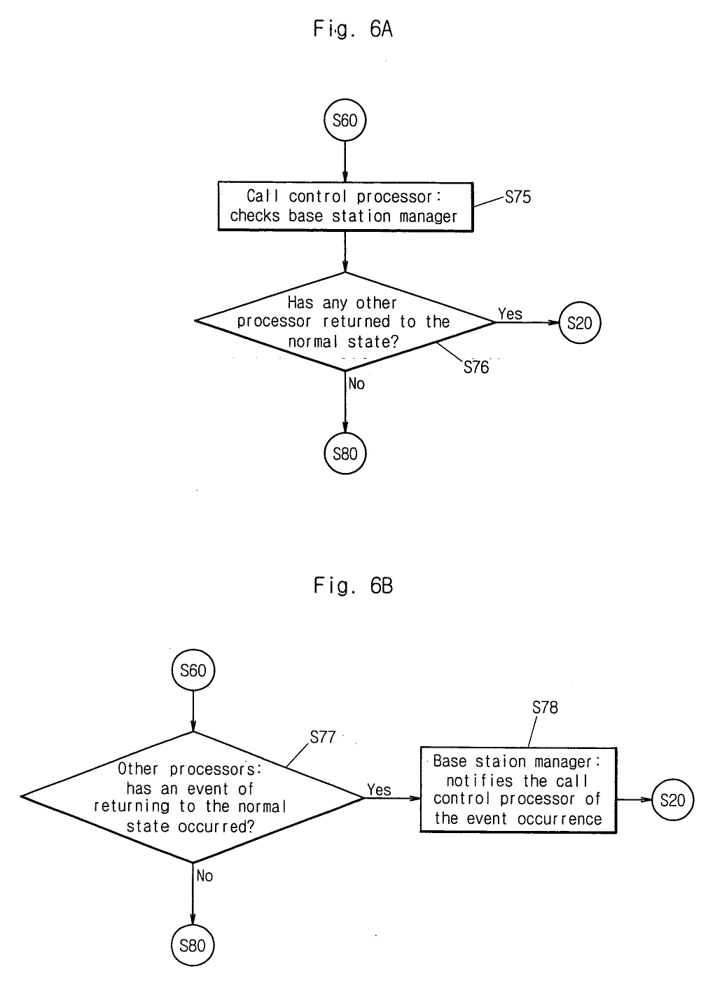

FIG. 6A is a detailed diagram of step S70 in the case where a base station manager is used. The call control processor checks the base station manager (S75). Accordingly, the call control processor may recognize whether a processor, which was in the abnormal state, has returned to the normal state (S76).

Alternatively, as illustrated in FIG. 6B, if any processor that was in the abnormal state returns to the normal state (S77), the base station manager can notify the call control processor of the occurrence of such an event (S78). Thus, the call control processor may recognize the processor's returning to the normal state.

As described above, according to the resource management method of embodiments of the present invention, even if resource allocation for an origination call or a page response call of a mobile hand station fails, the call is not released but maintained for re-allocation of other available resources requested. Accordingly, embodiments of the present invention decrease power consumption and time delay caused by the related art re-request of resource allocation after the call release. Further, the interference with other hand stations and the error occurrence caused by repeated detection of calls is also decreased.

Moreover, in the related art, if a mobile hand station fails to make a page response, service may not be provided because there would be no further response. In contrast, according to the resource management of embodiments of the present invention, even if resource allocation for a page response fails, the resource allocation may be requested again and thus the call may be maintained.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses if used are intended to cover the structures described herein as performing the recited function and not only structural equivalents but also equivalent structures.

What is claimed is:

1. A method for resource management of a call control processor, the method comprising:
allocating resources in response to an origination call or a page response call of a terminal in a mobile communication system; and
sending a request again for allocation of available resources to the resource management processor within a predetermined time period, even if a resource management processor fails to allocate resources upon receiving the request for resource allocation.

2. The method according to claim 1, further comprising:
(a) sending a request for resource allocation at the call control processor to a resource management processor;
(b) if resource allocation is denied, transmitting resource allocation failure message at the resource management processor to the call control processor;
(c) if the call control processor receives resource allocation failure message, checking at the call control processor whether any other call has been released or whether any other processor has returned to a normal state from an abnormal state within the predetermined time; and
(d) if it is determined from process (c) that any call has been released or that any processor has returned to the normal state from the abnormal state within certain time, sending a request for re-allocation of available resources at the call control processor to the resource management processor.

3. The method according to claim 2, wherein, if the allocation of resources in response to the available resource re-allocation request made by the call control processor in process (d) is denied, said processes (b) through (d) are conducted repeatedly.

4. The method according to claim 3, wherein the number of repetitions of process (b) through (d) is limited to a predetermined number.

5. The method according to claim 1, wherein said pre-determined time period is the time allocated for waiting from the terminal's receipt of the base station's response message regarding the call connection request made by the terminal until the requested call is connected.

6. The method according to claim 1, wherein the resource management processor is at least one of a service data unit (SDU) management processor managing service data units (SDUs), a network control processor managing network resources, and a base station processor managing channels.

7. The method according to claim 2, wherein said other processor of said processes (c) or (d) comprises a processor state block indicating a state of the relevant processor.

8. The method for resource management of a call control processor according to claim 7, wherein said other processor is at least one of a service data unit (SDU) management processor managing service data units (SDUs), a network control processor managing network resources, and a base station processor managing channels.

9. The method according to claim 7, wherein in said process (c) the call control processor checks whether any other processor has returned to the normal state from the abnormal state by checking the processor state blocks of the other processors.

10. The method according to claim 2, wherein in said process (c) if any other processor returns to the normal state from the abnormal state:
said other processor notifies the call control processor of the return to the normal state; and
the call control processor checks whether said other processor has returned to the normal state from the abnormal state through the other processor's notification of the event occurrence.

11. The method according to claim 2, wherein in said process (c) the call control processor checks a base station manager (BSM) that manages the base station controller of the mobile communication system, thereby checking whether any other processor has returned to the normal state from the abnormal state.

12. The method according to claim 2, wherein in said process (c) if any other processor returns to the normal state from the abnormal state:
notifying, the call control processor of the occurrence of the return to the normal state, by the base station manager; and
checking whether said other processor has returned to the normal state from the abnormal state through the base station manager's notification of the event occurrence.

13. The method of claim 1, wherein the terminal is a mobile hand station.

14. A mobile communication system comprising:
a call control processor configured to send a request for resource allocation to a resource management processor,
wherein the call control processor is configured to check whether any other call has been released or whether any other processor has returned to the normal state from the abnormal state within predetermined time period, if the call control processor receives a resource allocation failure message from the resource management processor, and
wherein the call control processor is configured to send a request for re-allocation of available resources to the resource management processor, if it is determined that any other call has been released or that any other processor has returned to the normal state from the abnormal state.

15. The mobile communication system according to claim 14, wherein the call control processor is in a base station controller.

16. The mobile communication system according to claim 14, wherein the resource management processor is at least one of a service data unit (SDU) management processor managing service data units (SDUs), a network control processor managing network resources, and a base station processor managing channels.

17. The mobile communication system according to claim 14, wherein said other processor comprises a processor state block indicating the state of the relevant processor.

18. The mobile communication system according to claim 17, wherein said other processor is at least one of a service data unit (SDU) management processor managing service data units (SDU), a network control processor managing network resources, and a base station processor managing channels.

19. The mobile communication system according to claim 17, wherein the call control processor is configured to check whether any other processor has returned to the normal state from the abnormal state by checking the processor state blocks of the other processors.

20. The mobile communication system according to claim 14, wherein if any other processor returns to the normal state from the abnormal state:
said other processor is configured to notify the call control processor of occurrence of the return to normal state; and
the call control processor is configured to check whether said other processor has returned to the normal state from the abnormal state through the other processor's notification of the return to normal state.

21. The mobile communication system according to claim 15, wherein:
the mobile communication system further comprises a base station manager configured to manage the base station controller, and
the call control processor is configured to check whether said other processor has returned to the normal state from the abnormal state by checking the base station manager.

22. The mobile communication system according to claim 14, wherein if any other processor returns to the normal state from the abnormal state:
the base station manager is configured to notify the call control processor of the occurrence of the return to normal state; and
the call control processor is configured to check whether said other processor has returned to the normal state from the abnormal state through the base station manager's notification of the return to the normal state.

23. The mobile communication system according to claim 14, wherein the mobile communication system comprises:
at least one mobile hand station;
at least one base station;
at least one base station controller; and
at least one mobile switching center (MSC).

24. A method for resource management comprising:
receiving a request for resource allocation from a terminal;
requesting resource allocation;
monitoring resource availability during a predetermined connection time; and
notifying the terminal of resource allocation failure after the predetermined connection time, a resource is unavailable within the predetermined connection time.

25. The method of claim 24, wherein monitoring resource availability comprises:
transmitting a resource allocation failure message to a call control processor, if resource allocation fails; and
determining whether at least one resource becomes available during the predetermined connection time.

26. The method of claim 25, wherein monitoring resource availability further comprises
notifying the call control processor of resource availability, if the requested resource becomes available within the predetermined connection time;
repeating the request for resource allocation by the call control processor; and
allocating the requested resource and connecting to the terminal.

27. The method of claim 24, wherein the resource allocation is provided by at least one of a service data unit (SDU) management processor managing service data units (SDUs), a network control processor managing network resources, and a base station processor managing channels.

28. The method of claim 24, further comprising:
allocating the requested resource, if the requested resource becomes available within the predetermined connection time; and
connecting the terminal, without sending a resource allocation failure message to the terminal even if an initial resource request resulted in a failure.

29. The method of claim 24, wherein the terminal is at least one of a mobile terminal, PDA, and mobile hand station.

30. The method of claim 25, wherein the call control processor is integrated into a base station.
